(19) United States
(12) Patent Application Publication
(10) Pub. No.: US 2015/0285447 A1
(43) Pub. Date: Oct. 8, 2015

(54) Multi Illumination Point Flashlight Headlamp

(71) Applicant: Mathew Inskeep, Highland Beach, FL (US)

(72) Inventor: Mathew Inskeep, Highland Beach, FL (US)

(21) Appl. No.: 14/243,456

(22) Filed: Apr. 2, 2014

(51) Int. Cl. F21L 4/00; A42B 1/24; F21V 33/00

(52) U.S. Cl. CPC F21L 4/005; F21V 33/0008; A42B 1/244; F21Y 2101/02

(57) ABSTRACT

A mufti illumination point flashlight headlamp that can be used as a traditional handheld flashlight or mounted in a head strap and used as a hands free headlamp.

This application claims the benefit and priority of U.S. patent application Ser. No. 61/808,974.

### STATEMENT REGARDING FEDERALLY SPONSORED RESEARCH

The invention was not made under government contract, nor was federal grant money used to fund the research.

### FIELD

Illumination devices, a wearable, portable flashlight headlamp.

### BACKGROUND

Individuals involved in working and or playing in the dark have at some point used a hand held flashlight for illumination. A headlamp provides effective hands free illumination that is useful when performing manual tasks in the dark or working in confined spaces such as an attic. The present invention offers the user the advantages of both a flashlight and a headlamp depending on the circumstances.

### SUMMARY

The disclosure relates to a multi illumination point flashlight headlamp that can be worn on the user's head or hand held as a traditional flashlight. An objective of the invention is to provide a portable illumination device that is easy to use and has multiple applications depending on the user's circumstances. A traditional flashlight must be held and cannot be operated ‘hands free’. The present invention provides multiple usages by combining the advantages of a headlamp and flashlight. It can be held in the user's hand and operated like a traditional flashlight or easily affixed to the user's head, functioning as a headlamp.

The following description of the invention pertains to a Multi Illumination Point Flashlight Headlamp. This particular flashlight contains a main LED lamp located in the front of the body together with a side LED lamp located at the center of the body. The LED's contained within are high power LED lamps to be utilized as a hand held lamp or as a headlamp. The power source driving this flashlight will be by battery cells.

### DRAWINGS

FIG. 1 is a perspective view of the main body assembly.

FIG. 2 is an internal electrical construction of the invention.

FIG. 3 is a perspective view of the body; which includes a view of the headlamp retaining features.

FIG. 4 is a perspective view of the invention holstered in the headstrap.

### DETAILED DESCRIPTION

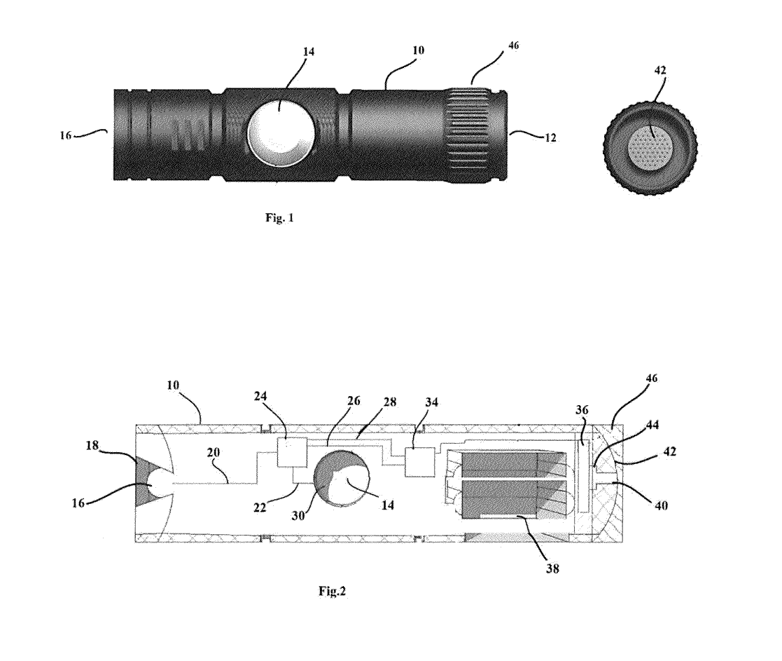

The complete light unit consist of a dual high power LED lamps as depicted in FIG. 1. The present invention combines a hand-held function in conjunction with a head-lamp function. These features can be described as multi illumination points.

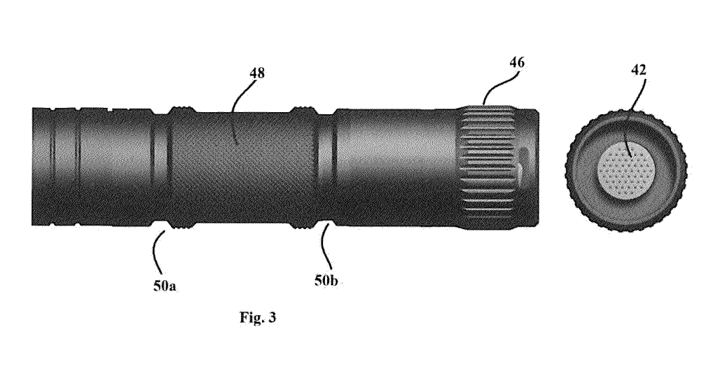

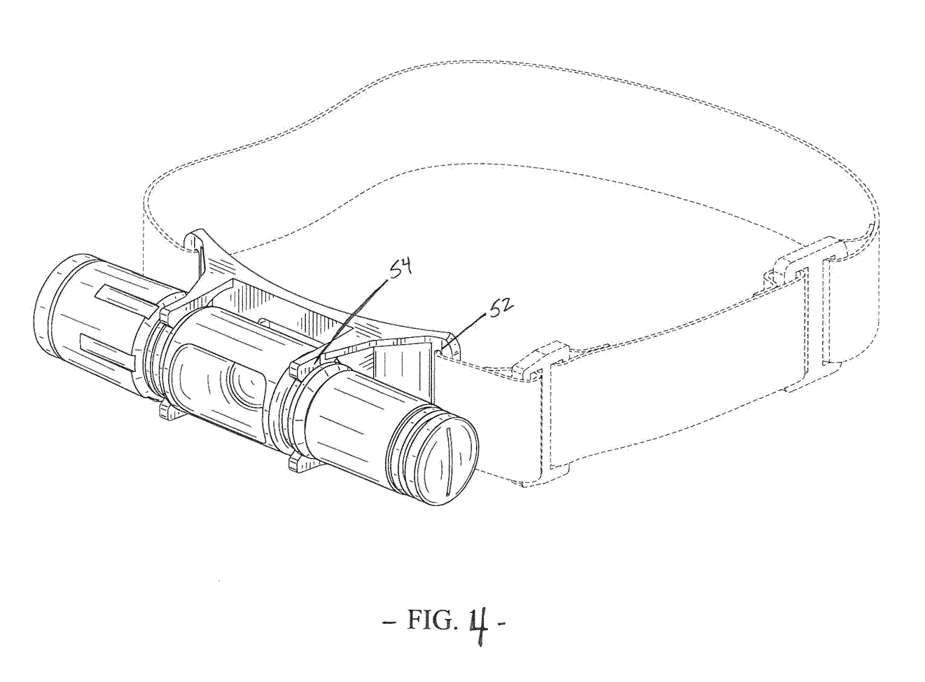

Referring now to FIG. 1, a view of the present invention. The main body (10) is cylindrical tube shape fabricated from aluminum anodize material for durability, measuring approximately six inches in length. The main body (10) is strong and lightweight, which makes it convenient for the application specifically that of the headlamp function. The main LED lamp is located at the top end of the main body (10) which is intended to be used when the flashlight is hand-held, the main LED lamp (16) is recessed into the body for protection as well as heat dissipation. The secondary LED lamp (14) is also recessed and is located on the side of the main body (10) which is intended for when the flashlight is used as a head lamp. The head lamp function will be described later on FIG. 3. The power source for this multi illumination point flashlight comes from user replaceable battery cells which are loaded through the battery cap (12) located at the bottom of the main unit (10).

FIG. 2 is an outline of the internal electrical components required to operate the flashlight headlamp. This image depicts the position of each major internal component. It should be noted, that the exact position of these components can shift slightly. Prior to first use, the user will need to install a pair of battery cells into the battery compartment (38) of the flashlight by unscrewing the threaded battery cap (12). There are extruded ribs (46) around the battery cap (12) for ease grip during battery installation. Once the battery cells are properly inserted, the battery cap (12) can be screwed back on firmly and the flashlight is ready for use. Referring again to the battery cap (12) functions, there is a built-in external soft flexible silicone control pad (42) as shown on FIG. 1 that will be used to energize and de-energize the flash light. The material is soft and contains a conductive contact pad (40) that when depressed against the contact (44) point on the main circuit board (36) it completes the circuit allowing the logic function to commence. The best way to describe the silicone conductive pad (40) and (42) is to think of it as a momentary on/off switch. The initial signal is received by the circuit board (36) whenever the switch is closed. Once the logic function is read by the circuit board (36) the user selects which light to power by pressing a single time the top of the silicone pad (42). The logic function is as follows: the main LED lamp (16) becomes energized, when pad (42) is initially depressed, when the pad (42) is depressed a second time, the side LED lamp (14) becomes energized, when the pad (42) is depressed a third time only the side LED lamp is energized and when the pad (42) is depressed a fourth time all LED lamps are de-energize. The main circuit board (36) receives its power from the battery cells. The battery cells and the main circuit board (36) are always electrically connected. The energy consumed by the main circuit board (36) when the flashlight is not in use is negligible. As previously stated, the control signal is activated when the silicone pad (42) is depressed. The signal is received and processed by the LED control circuit (34) which reads the sequence and sends a signal to the LED drive circuit (24) via bus lines (26, 28). Once the LED drive circuit (24) receives the instruction, the appropriate LED lamp is energizes via conductive paths (20, 22). The logic process is repeated every time one cycle of the logic is completed. Additional mechanical structures on FIG. 2 are the LED lamp reflector (30) and (18) which have the LED lamp as radiation light source. The reflector is parabolic shape which emits a direct beam from the LED lamps. There is a transparent cover to protect the internal light from any impacts.

In FIG. 3, there are several additional features molded into the body that facilitate the usage of the flashlight. First, the main body contains a knurl (48) feature which surrounds the embodiment. This knurl (48) provides a secure and comfortable grip to the user during handling of the flashlight, preventing accidental slip from the user's hand. Also, the secondary feature is a set of retention channels (50a, 50b) that provides retention by means of an external bracket. The external bracket will be a head strap with a mechanical retainer that will allow for the flashlight to rotate around its axis.

Referring to FIG. 4, there is a representation of the head strap mechanism that will hold the flashlight in place when the user decides to use it as a hands-free device by means of head strap. The headband will go around the headband retainer channels that will hold the flashlight in the desired position. The flashlight will be located around the locking tab (54) which will go around the retention channels (50a, 50b) previously described on FIG. 3. Once the flashlight is loaded the entire system can be locked in place. All of the components described on FIG. 1 through 4 are intended to work in harmony to produce the desired outcome, which is to produce a comfortable and easy to use multi illumination point flashlight headlamp.

What is claimed is:

1. A multi illumination flashlight tool with a high power light emitting diode on the body and front of body.

2. A multi illumination flashlight tool with a high power light emitting diode and retention channels

3. A multi illumination flashlight tool with a high power light emitting diode with retention channels and headband retention features.
